(19) United States
(12) Patent Application Publication
(10) Pub. No.: US 2024/0289615 A1
(43) Pub. Date: Aug. 29, 2024

(54) NEURAL NETWORK UPDATE DEVICE, NON-TRANSITORY RECORDING MEDIUM RECORDING NEURAL NETWORK UPDATE PROGRAM, AND NEURAL NETWORK UPDATE METHOD

(71) Applicant: OLYMPUS MEDICAL SYSTEMS CORP., Tokyo (JP)

(72) Inventors: Jun ANDO, Tokyo (JP); Hiroki TAKEUCHI, Kaga-shi (JP)

(73) Assignee: OLYMPUS MEDICAL SYSTEMS CORP., Tokyo (JP)

(21) Appl. No.: 18/659,852

(22) Filed: May 9, 2024

Related U.S. Application Data
(63) Continuation of application No. PCT/JP2022/006424, filed on Feb. 17, 2022.

(51) Int. Cl. G06N 3/08

(52) U.S. Cl. CPC G06N 3/08

(57) ABSTRACT

A neural network update device includes a processor that includes hardware. The processor is configured to, with respect to a plurality of output data obtained as a result of inputting a plurality of training data into a neural network, compare the plurality of output data with a plurality of pieces of correct answer information allocated respectively to the plurality of training data to calculate a loss value for each of the plurality of output data, and for relevant output data, the loss value for which meets a predetermined reference, process the correct answer information corresponding to the relevant output data, or process the training data corresponding to the relevant output data, to update the neural network by using the loss value of the output data of the neural network after the processing.

### CROSS-REFERENCE TO RELATED APPLICATION

This application is a continuation application of PCT/JP2022/006424 filed on Feb. 17, 2022, the entire contents of which are incorporated herein by this reference.

### BACKGROUND OF THE INVENTION

### 1. Field of the Invention

The present disclosure relates to a neural network update device configured to perform learning by using teaching data including an image unsuitable for a determination by an AI, a non-transitory recording medium recording a neural network update program, and a neural network update method.

### 2. Description of the Related Art

In recent years, a technique for supporting determination, which had been performed visually by human beings, by utilizing an AI (artificial intelligence) based on image data, has developed in various fields.

The above-described AI is implemented by constructing, in response to training data inputted, a function of outputting a determination result corresponding to the training data. A neural network is often used as the function. A learning technology of AI that uses a multi-layer neural network is referred to as deep learning. In deep learning, first, a large volume of teaching data, which includes a pair of training data and correct answer information corresponding to the training data, is prepared. The correct answer information is manually created by annotation. The neural network includes a large number of product-sum operations, and multipliers are referred to as weights. The “learning” is performed by adjusting the weights such that an output, which is obtained when the training data included in the teaching data is inputted into the neural network, is brought close to the corresponding correct answer information. An inference model, which is a neural network after learning, will be able to perform “inference” for deriving an appropriate solution to an unknown input.

In order to create an inference model for determining a lesion part in a body, endoscopic examination images can be adopted as images serving as a basis for teaching data.

However, in an endoscopic examination, since observation is performed while operating an endoscope, a moving image in which diagnosis processes are recorded includes an image unsuitable for diagnosis, such as a blurred and camera-shake image, a dark image with insufficient light amount, or the like. If learning is performed using the teaching data including such an unsuitable image, an inference performance of a created inference model will deteriorate. In view of the above, Japanese Patent Application Laid-Open Publication No. 2020-38514 discloses a method of cleansing the learning data before the learning.

### SUMMARY OF THE INVENTION

A neural network update device according to one aspect of the present disclosure includes a processor including hardware, and the processor is configured to: with respect to a plurality of output data obtained as a result of inputting a plurality of training data into a neural network, compare the plurality of output data with a plurality of pieces of correct answer information associated with the plurality of training data, to calculate a loss value for each of the plurality of output data; select, among the plurality of output data, relevant output data, the loss value for which meets a predetermined reference, and irrelevant output data, the loss value for which does not meet the predetermined reference; and create processed correct answer information by processing the correct answer information compared with the relevant output data, compare the relevant output data with the processed correct answer information, to output a processed loss value, and update the neural network by using the processed loss value, or create processed training data by processing the training data associated with the relevant output data, input the processed training data into the neural network, to cause the neural network to output processed output data obtained as a result of classifying the processed training data, compare the processed output data with the correct answer information associated with the relevant output data to output a processed loss value, and update the neural network by using the processed loss value.

A non-transitory recording medium recording a neural network update program according to one aspect of the present disclosure records the neural network update program configured to cause a neural network update device to execute, with respect to a plurality of output data obtained as a result of inputting a plurality of training data into a neural network, processes of: comparing the plurality of output data with a plurality of pieces of correct answer information associated with the plurality of training data, to calculate a loss value for each of the plurality of output data; selecting, among the plurality of output data, relevant output data, the loss value for which meets a predetermined reference, and irrelevant output data, the loss value for which does not meet the predetermined reference; and creating processed correct answer information by processing the correct answer information compared with the relevant output data, comparing the relevant output data with the processed correct answer information, to output a processed loss value, and updating the neural network by using the processed loss value, or creating processed training data by processing the training data associated with the relevant output data, inputting the processed training data into the neural network to cause the neural network to output processed output data obtained as a result of classifying the processed training data, comparing the processed output data with the correct answer information associated with the relevant output data to output a processed loss value, and updating the neural network by using the processed loss value.

A neural network update method according to one aspect of the present disclosure is a neural network update method by using a neural network update device including a teaching data acquisition unit, a neural network application unit, and a teaching data correction unit. The method includes: acquiring teaching data including a plurality of training data and a plurality pieces of correct answer information associated with the plurality of training data, by the teaching data acquisition unit; inputting the plurality of training data into a neural network to cause the neural network to output a plurality of output data, which are obtained as a result of classifying the plurality of training data and which are associated respectively with the plurality of training data, by the neural network application unit; comparing the plurality of output data with the plurality of pieces of correct answer information associated with the plurality of training data to calculate a loss value for each of the plurality of output data, by the neural network application unit; selecting, among the plurality of output data, relevant output data, the loss value for which meets a predetermined reference, and irrelevant output data, the loss value for which does not meet the predetermined reference, by the neural network application unit; and creating, by the teaching data correction unit, processed correct answer information by processing the correct answer information compared with the relevant output data, comparing, by the neural network application unit, the relevant output data with the processed correct answer information to output a processed loss value, and updating, by the neural network application unit, the neural network by using the processed loss value, or creating, by the teaching data correction unit, processed training data by processing the training data associated with the relevant output data, inputting, by the neural network application unit, the processed training data into the neural network to cause the neural network to output processed output data obtained as a result of classifying the processed training data and comparing the processed output data with the correct answer information associated with the relevant output data to output a processed loss value, and updating, by the neural network application unit, the neural network by using the processed loss value.

### BRIEF DESCRIPTION OF THE DRAWINGS

FIG. 1 is a block diagram showing a neural network update device according to a first embodiment of the present disclosure.

FIG. 2 is an explanatory diagram for explaining a deterioration of an inference accuracy of an inference model to be acquired by learning in a case where teaching data including an unsuitable image is used in a comparison example of the neural network update device.

FIG. 3 is a flowchart for explaining an operation of a first embodiment.

FIG. 4 is a flowchart for explaining the operation of the first embodiment.

FIG. 5 is an explanatory diagram for explaining the operation of the first embodiment.

FIG. 6 is an explanatory diagram for explaining the operation of the first embodiment.

FIG. 7 is an explanatory diagram for explaining the operation of the first embodiment.

FIG. 8 is an explanatory diagram for explaining the operation of the first embodiment.

FIG. 9 is an explanatory diagram for explaining an effect of the first embodiment for an example similar to that in FIG. 2.

FIG. 10 is a block diagram showing a second embodiment of the present disclosure.

FIG. 11 is a flowchart for explaining an operation of the second embodiment.

FIG. 12 is an explanatory diagram for explaining the operation of the second embodiment.

FIG. 13 is an explanatory diagram for explaining the operation of the second embodiment.

FIG. 14 is an explanatory diagram for explaining the operation of the second embodiment.

FIG. 15 is an explanatory diagram for explaining the operation of the second embodiment.

### DETAILED DESCRIPTION OF THE PREFERRED EMBODIMENTS

Hereinafter, embodiments of the present disclosure are described in detail with reference to drawings.

### First Embodiment

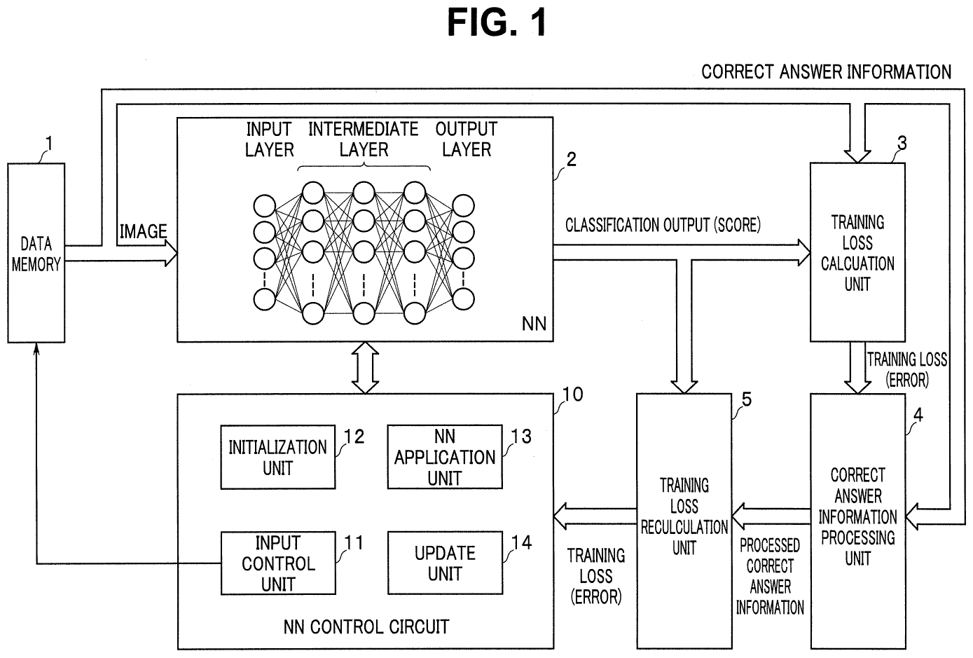

FIG. 1 is a block diagram showing a neural network update device according to the first embodiment of the present disclosure. In the present embodiment, when learning of a neural network is performed, training losses are calculated, and regarding teaching data the training loss for which is higher than a predetermined threshold, a category of correct answer information is changed to a category of unsuitable recognition (hereinafter, referred to as “unknown”), to thereby improve an inference accuracy of an inference model to be acquired by learning even in a case where the teaching data includes an unsuitable image. Note that the present embodiment will be described by taking a case where endoscopic examination images are used as the teaching data, to create the inference model for performing recognition processing of a lesion part, as an example. However, the present embodiment can be applied to a creation of an inference model for performing various kinds of other classifications.

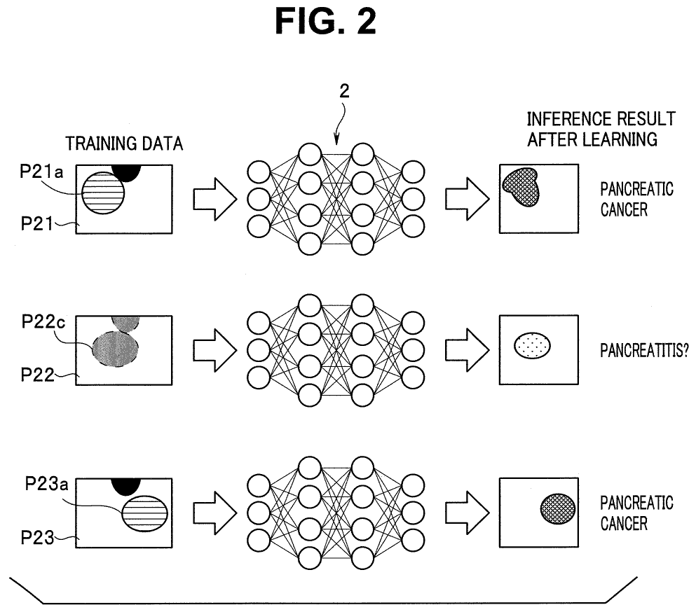

FIG. 2 is an explanatory diagram for explaining a comparison example of the neural network update device. First, with reference to FIG. 2, description will be made on a deterioration of the inference accuracy of the inference model to be acquired by learning in the case where the teaching data including an unsuitable image is used in the comparison example.

The teaching data includes training data for learning and correct answer information imparted as annotation to each of the training data. As the training data, a large number of images obtained by picking up an image of a lesion part in an endoscopic examination are adopted, for example. In the example shown in FIG. 2, each of the training data (images P21 to P23) includes “pancreatic cancer” or “pancreatitis” added as the correct answer information according to a type of the lesion part in each of the images. Note that image parts P21a and P23a in the image P21 and P23 each show pancreatic cancer. An image part P22c in the image P22 shows pancreatitis. However, a blurring and a camera-shake occur in the image part P22c. Conventionally, such an image P22 has been removed by cleansing before learning, and has not been used for learning. Note that examples of the unsuitable image include an image with blur and shake occurred, for example, by a focus shift or camera-shake, a dark image with insufficient light amount, an image in which a size of the lesion part is relatively small, and the like.

These images P21 to P23 are inputted into a neural network 2 to be learned. In the process of learning, the neural network 2 outputs a classification output that uses a probability value (hereinafter referred to as “score”) for each classification, as output data. An error between the classification output and the correct answer information is calculated as a training loss, and parameters of the neural network 2 are updated to reduce the training loss. An unknown image is inputted into the neural network 2 (inference model) acquired by such learning, to thereby be capable of acquiring a classification output indicating whether the inputted image is “pancreatic cancer” or “pancreatitis”.

Note that, by increasing the number of classification outputs, it is possible to cause the neural network 2 to output a classification output of “unknown” which indicates that the unknown inputted image does not belong to any of the classifications imparted as the annotation at the time of creating the teaching data.

Incidentally, there is a case where the training data includes an unsuitable image with blur and camera-shake, like the image P22. As described above, even to such an unsuitable image, there is a case where some correct answer information such as “pancreatic cancer” or “pancreatitis” is added at the time of annotation. In other words, for the images in the training data, even if the images are unsuitable images, sometimes “unknown” is not set as the correct answer information.

The classification output of “pancreatic cancer”, which is to be outputted in response to an input of an unsuitable image with blur and camera-shake to which “pancreatic cancer” is added as the correct answer information, is likely to have a low probability value, which results in a large training loss. In such a case, the neural network is updated such that the training loss is forcibly decreased, that is, the neural network is made to determine that the image is “pancreatic cancer” despite that the image is an unsuitable image, resulting in a deterioration of an inference accuracy of the inference using the neural network 2 which is constructed as a result of repeating the above-described learning.

In view of the above, in the present embodiment, the correct answer information for the training data which is a blurred image, or the like is processed as “unknown” in the process of learning, to thereby obtain an effect equivalent to that to be obtained by excluding the training data which is the blurred image, or the like, from the teaching data.

In FIG. 1, the neural network update device includes a data memory 1, the neural network 2, a training loss calculation unit 3, a correct answer information processing unit 4, a training loss recalculation unit 5, and a neural network control circuit (hereinafter, referred to as an NN control circuit) 10. Note that all or each of the training loss calculation unit 3, the correct answer information processing unit 4, the training loss recalculation unit 5, and the NN control circuit 10 may be configured of one or more processors using a CPU (Central Processing Unit) or an FPGA (Field Programmable Gate Array), etc. The one or more processors may operate to control respective units according to a program stored in a memory not shown, or may implement a part or all of the functions of the respective units by an electronic circuit of hardware. In addition, the neural network 2 may be configured of hardware, and the functions of the neural network 2 may be implemented by a program.

The data memory 1 is configured of a predetermined storage medium, and configured to store teaching data including a plurality of training data and a plurality of pieces of correct answer information. As described above, to each of all the training data, the correct answer information indicating the classification other than “unknown” is allocated. The data memory 1 is controlled by the NN control circuit 10, to output the training data to the neural network 2, and output the correct answer information to the training loss calculation unit 3 and the correct answer information processing unit 4.

The neural network 2 is constituted of an input layer, an intermediate layer (hidden layer), and an output layer. These layers are each constituted of a plurality of nodes shown by circles. Each of the nodes is connected to the nodes in previous and subsequent layers, and to each one of the connections, a parameter called a weighting factor is given. Learning is processing for updating the parameters to minimize the training loss to be described later. For example, a convolutional neural network (CNN) may be used as the neural network 2.

The NN control circuit 10 includes an input control unit 11, an initialization unit 12, an NN application unit 13, and an update unit 14. The input control unit 11, which is a teaching data acquisition unit, acquires the teaching data including the training data and the correct answer information to store the acquired teaching data in the data memory 1 and controls the output of the training data and the correct answer information in the data memory 1. The initialization unit 12 is configured to initialize the parameters of the neural network 2. The NN application unit 13 applies the training data read from the data memory 1 to the neural network 2, to cause the neural network 2 to output the classification output. The update unit 14 updates the parameters of the neural network 2 based on the training loss.

The neural network 2 is controlled by the NN control circuit 10 to output, as the classification output, for each of the inputted images, a probability value (score) indicating which classification each of the inputted images is classified into with a high probability. The classification outputs are provided to the training loss calculation unit 3 and the training loss recalculation unit 5. The training loss calculation unit 3 receives from the data memory 1 the pieces of correct answer information allocated respectively to the images corresponding to the respective classification outputs, and calculates an error between each of the classification outputs and each of the pieces of correct answer information, as the training loss. In the comparison example in FIG. 2 described above, the parameters of the neural network 2 are updated based on the training loss.

In contrast, in the present embodiment, the training loss outputted from the training loss calculation unit 3 is supplied to the correct answer information processing unit 4 (also referred to as a teaching data correction unit). The correct answer information processing unit 4 is configured to compare the output data with a plurality of pieces of correct answer information associated with the training data, to thereby calculate the loss value (training loss) for each of the output data. Then, the correct answer information processing unit 4 is configured to select, among the output data, relevant output data, the loss value for which meets a predetermined reference, and irrelevant output data, the loss value for which does not meet the predetermined reference.

An example of a method of judging whether the loss value meets the predetermined reference includes a method of comparing a predetermined threshold with the training loss. In this case, the output data is judged as the relevant output data when the training loss for the output data exceeds the predetermined threshold, and the output data is judged as the irrelevant output data when the training loss for the output data is equal to or smaller than the threshold.

Another example of the method of judging whether the loss value meets the predetermined reference includes a method of selecting, among the output data, the output data within a predetermined number in an order starting from the one, the loss value for which is the largest, as the relevant output data.

Yet another example of the method of judging whether the loss value meets the predetermined reference includes a method of selecting, among the output data, the output data within a predetermined number in an order starting from the one, the loss value for which is the smallest, as the irrelevant output data.

The correct answer information processing unit 4 is configured to process the correct answer information compared with the relevant output data, the loss value for which meets the predetermined reference. In the present embodiment, the correct answer information processing unit 4 receives from the data memory 1 the correct answer information corresponding to each of the training losses, and processes the correct answer information as “unknown”, regarding the training loss exceeding the predetermined threshold, that is, the training loss in which the error between the classification output and the correct answer information is relatively large. The correct answer information processing unit 4 outputs the correct answer information subjected to the processing (processed correct answer information) to the training loss recalculation unit 5.

The training loss recalculation unit 5 calculates, for each classification output outputted from the neural network 2, the error between the classification output and the processed correct answer information, as the training loss (hereinafter, also referred to as the processed loss value), and supplies the calculated training loss for each classification output to the NN control circuit 10. Note that, after the processed correct answer information is created, the training data associated with the relevant output data is inputted into the neural network, to cause the neural network to output the output data obtained as a result of classifying the training data, and the output data may be compared with the processed correct answer information, to thereby obtain the processed loss value.

The update unit 14 of the NN control circuit 10 uses the training loss calculated by the training loss recalculation unit 5 to update the parameters of the neural network 2. For example, the update unit 14 may update the parameters according to an algorithm of an existing SGD (stochastic gradient descent method). The updating expression in the SGD is known, and each of the parameters of the neural network 2 is calculated by substituting the value of the training loss in the updating expression in the SGD.

Note that the neural network may be updated using the loss value associated with the irrelevant output data in addition to the processed loss value.

The neural network 2 is controlled by the NN control circuit 10 to classify the inputted image based on the updated parameters. After that, the same operation is repeated, and the learning is performed.

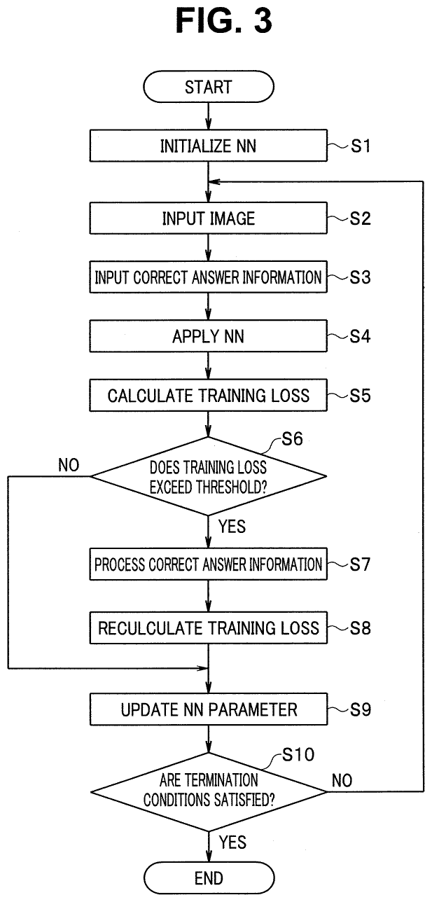

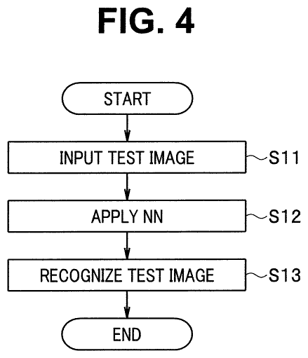

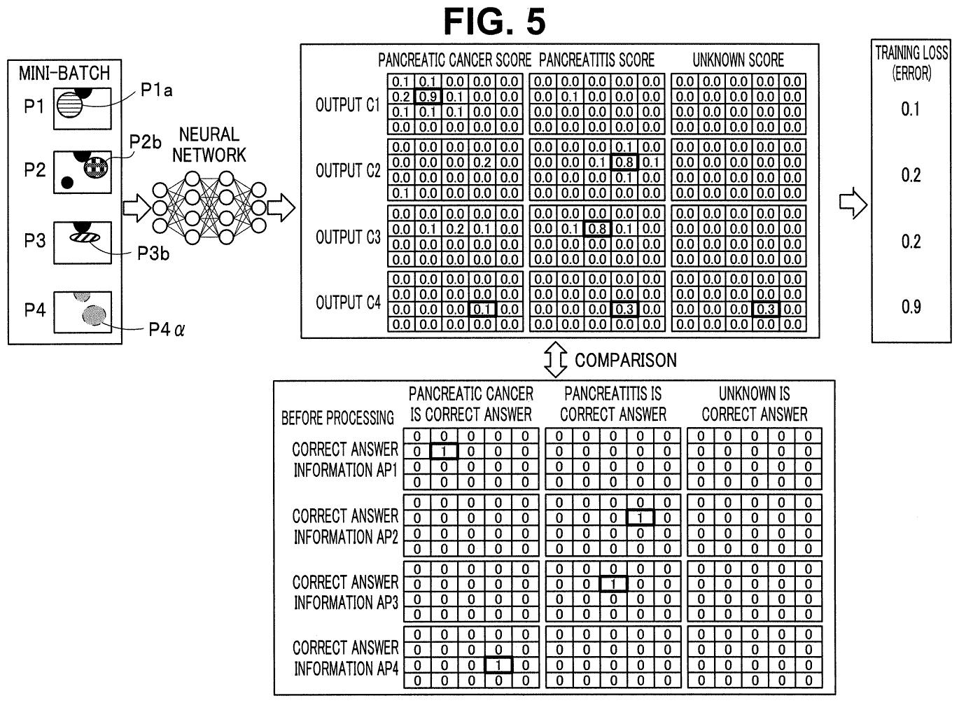

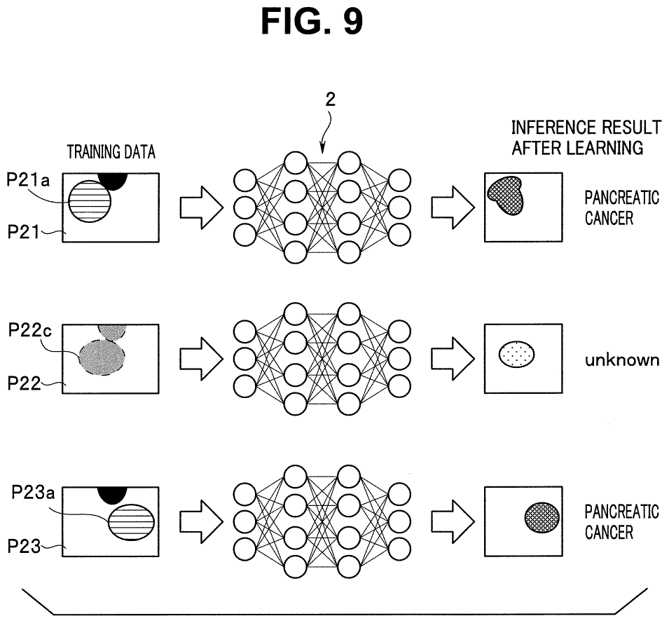

Next, the operation of the embodiment thus configured will be described with reference to FIGS. 3 to 9. FIG. 3 and FIG. 4 are flowcharts each explaining the operation of the first embodiment. FIGS. 5 to 8 are explanatory diagrams each explaining the operation of the first embodiment. In addition, FIG. 9 is an explanatory diagram explaining an effect of the first embodiment for the example similar to that shown in FIG. 2.

In S1 in FIG. 3, the initialization unit 12 of the NN control circuit 10 initializes the parameters of the neural network 2. However, the initialization unit 12 is not an essential constituent element, and the initialization of the parameters is not an essential step. In FIG. 3, after the start of the processing steps, the NN is initialized, but the present disclosure is not limited thereto. For example, the present disclosure can be applied to the NN cultivated by another learning method, without initializing the NN. The input control unit 11 of the NN control circuit 10 inputs the image which is training data stored in the data memory 1 into the neural network 2 (S2). In addition, the input control unit 11 inputs the correct answer information stored in the data memory 1 into the training loss calculation unit 3 and the correct answer information processing unit 4 (S3). Note that, in the neural network, among a large number of images, the images in a unit of a predetermined number (hereinafter, referred to as mini-batch) are extracted, and learning is performed for the extracted images in mini-batch. This learning for the images in mini-batch is executed for the number of data, to perform the learning of one unit (hereinafter, referred to as epoch). For example, the number of epochs to be executed in the learning is sometimes determined in advance.

The left end portion in FIG. 5 shows the mini-batch constituted of four images P1 to P4 which are the training data. The image P1 in the mini-batch includes an image part P1a of pancreatic cancer in the image PL. In addition, the images P2 and P3 respectively include image parts P2b, P3b of pancreatitis in the images. Furthermore, the image P4 is an unsuitable image including a blurred image part P4a of pancreatic cancer or pancreatitis. Note that when there is no need to distinguish among the images P1 to P4, the images P1 to P4 may be referred to as an image P representatively.

The correct answer information indicating that the image part P1a is the image part of pancreatic cancer is added to the image P1. Similarly, the correct answer information indicating that the image part P2b is the image part of pancreatitis is added to the image P2, and the correct answer information indicating that the image part P3b is the image part of pancreatitis is added to the image P3. Furthermore, the correct answer information indicating that the image part P4a is the image part of pancreatic cancer or pancreatitis is added to the image P4.

The lower portion in FIG. 5 shows one example of the correct answer information. FIG. 5 shows the pieces of correct answer information AP1 to AP4 set respectively for the images P1 to P4. Note that when there is no need to distinguish among the pieces of correct answer information AP1 to AP4, the pieces of correct answer information AP1 to AP4 may be referred to as correct answer information AP representatively. The correct answer information AP indicates a probability that each of 5×4 regions, which is obtained by dividing the image P, falls under which of the categories, i.e., pancreatic cancer, pancreatitis, or “unknown”.

For example, the correct answer information AP1 indicates that the probability of pancreatic cancer is 1 (bold frame portion) for the region corresponding to the image part P1a of the image P1 and 0 for other regions. In addition, the correct answer information AP1 indicates that both of the score of pancreatitis and the probability of “unknown” are 0 for all the regions. The correct answer information AP2 indicates that the probability of pancreatitis is 1 (bold frame portion) for the region corresponding to the image part P2b of the image P2 and 0 for other regions. In addition, the correct answer information AP2 indicates that both of the probability of pancreatic cancer and the probability of “unknown” are 0 for all the regions. The correct answer information AP3 indicates that the probability of pancreatitis is 1 (bold frame portion) for the region corresponding to the image part P3b of the image P3 and 0 for other regions. In addition, the correct answer information AP3 indicates that both of the probability of pancreatic cancer and the probability of “unknown” are 0 for all the regions. Furthermore, the correct answer information AP4 indicates that the probability of pancreatic cancer is 1 (bold frame portion) for the region corresponding to the image part P4a of the image P4 and 0 for other regions. In addition, the correct answer information AP4 indicates that both of the probability of pancreatitis and the probability of “unknown” are 0 for all the regions.

Thus, in the example shown in FIG. 5, the correct answer information indicating the probability of “unknown” is not included. It can be considered that the correct answer information indicating the probability of “unknown” is preferable for the image part P4a of the image P4. However, the correct answer information indicating the probability of pancreatic cancer is set also for the image part P4a.

The NN application unit 13 applies such a mini-batch to the neural network 2 (S4). Then, the neural network 2 outputs the classification outputs shown in the upper middle part in FIG. 5. In the example shown in FIG. 5, for each 5×4 region of the image P, the score of pancreatic cancer (pancreatic cancer score), the score of pancreatitis (pancreatitis score), and the score of “unknown” (unknown score) are shown. Outputs C1 to C4 in FIG. 5 respectively indicate the classification outputs of the neural network 2 for the images P1 to P4.

As shown in the output C1 in FIG. 5, for the image P1, the score of pancreatic cancer is the highest of 0.9 (bold frame portion) for the region of the image part P1a. Note that the scores for other regions of the image P1 are relatively small, and the value of 0.9 is a relatively high value. In addition, as shown in the output C2, for the image P2, the score of pancreatitis is the highest of 0.8 (bold frame portion) for the region of the image part P2b. The scores for other regions of the image P2 are relatively small, and the value of 0.8 is a relatively high value. In addition, as shown in the output C3, for the image P3, the score of pancreatitis is the highest of 0.8 (bold frame portion) for the region of the image part P3b. The scores for other regions of the image P3 are relatively small, and the value of 0.8 is a relatively high value.

In contrast, as shown in the output C4, for the region of the image part P4a of the image P4, the score of pancreatic cancer is 0.1 (bold frame portion), the score of pancreatitis is 0.3 (bold frame portion), and the score of “unknown” is 0.3 (bold frame portion). In other words, these scores show that it is difficult for the neural network 2 to classify the image P4 into the category of pancreatic cancer indicated by the correct answer information, since the image P4 is an unsuitable image in which a blurring occurs.

Each of the classification outputs from the neural network 2 is provided to the training loss calculation unit 3 and the training loss is calculated (S5). The right end portion in FIG. 5 shows the training loss values for the respective images P1 to P4. As shown in FIG. 5, for each of the images P1 to P3, the score of pancreatic cancer or pancreatitis is relatively high, and the value of the training loss is 0.1 or 0.2, which is relatively small. In contrast, the correct answer information for the image part P4a of the image P4 is set to pancreatic cancer, despite the fact that the image part P4a of the image P4 is a blurred image. Therefore, the score of pancreatic cancer is relatively low and the training loss is relatively large (0.9). The training loss calculation unit 3 outputs the calculated training loss to the correct answer information processing unit 4.

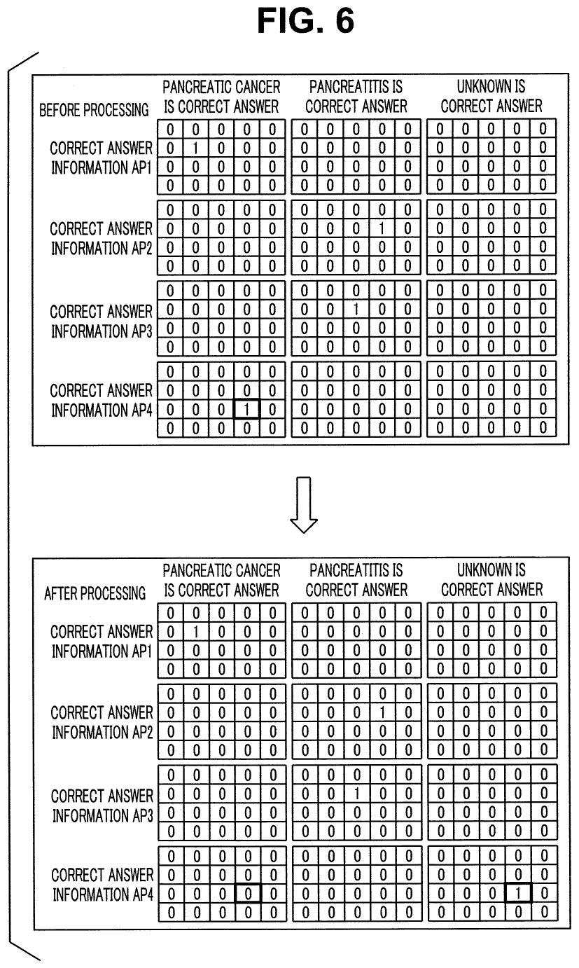

In the present embodiment, the correct answer information processing unit 4 determines whether the training loss exceeds the threshold in S6. If it is supposed that the threshold is 0.8, for example, the training loss for the image P4 exceeds the threshold in the example shown in FIG. 5. When determining that the training loss exceeds the threshold (YES determination in S6 in FIG. 3), the correct answer information processing unit 4 processes the correct answer information for the image P4 to “unknown” (S7). FIG. 6 shows the processing. In the correct answer information AP4 for the image P4, the probability that pancreatic cancer is the correct answer for the image part P4a is 1 (bold frame portion) before the processing, whereas, after the processing, the probability that pancreatic cancer is the correct answer is 0 (bold frame portion), and the probability that “unknown” is the correct answer is 1 (bold frame portion). Note that the training loss calculated in the training loss calculation unit 3 does not exceed the predetermined threshold (NO determination in S6), the processing proceeds to S9.

The correct answer information processing unit 4 outputs the processed correct answer information after the processing to the training loss recalculation unit 5. The training loss recalculation unit 5 also receives the classification outputs from the neural network 2, and the training loss recalculation unit 5 recalculates the training loss for each of the classification outputs from the neural network 2 using the processed correct answer information (S8).

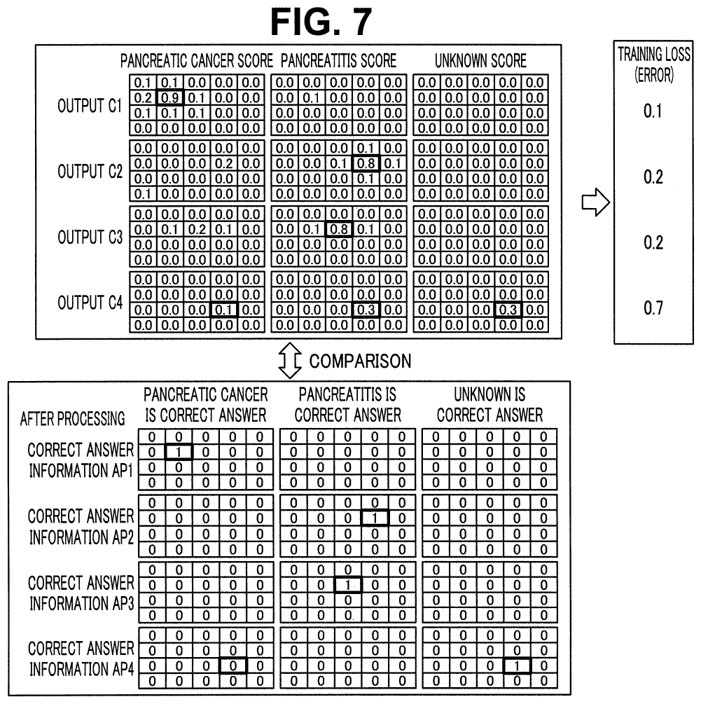

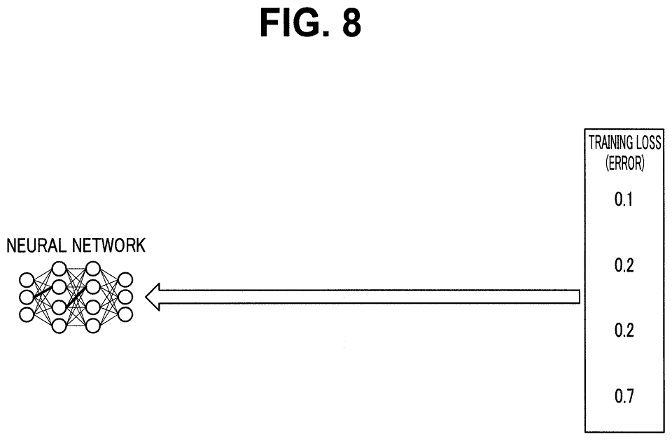

FIG. 7 shows the training loss obtained by the training loss recalculation. In the example shown in FIG. 7, the correct answer information for the image part P4a of the image P4 has been changed to “unknown”, the training loss value varies to the relatively small value (0.7). The training loss recalculation unit 5 outputs the calculated training loss values to the neural network 2. As shown in FIG. 8, the update unit 14 of the neural network 2 updates the parameters of the neural network 2 based on the inputted training loss values, by using the SGD method, for example (S9).

Next, the NN application unit 13 determines whether termination conditions for the learning are satisfied (S10). As described above, the processing for performing learning by extracting the training data in the mini-batch is repeated for the number of data, until a prescribed number of epochs has been reached. The NN application unit 13 determines whether the prescribed number of epochs has been reached, and if the prescribed number of epochs has not been reached (NO determination in S10), the processing returns to S2 so that S2 to S10 are repeated. Meanwhile, if the prescribed number of epochs has been reached (YES determination in S10), the NN application unit 13 terminates the processing.

When the learning ends, a test is executed. FIG. 4 shows a flow of this test. In S11 in FIG. 4, a test image is inputted. The test image is an unknown image. The NN application unit 13 applies the test image stored in the data memory 1 to the neural network 2 (S12). As a result, a classification output, which is a recognition result, is acquired from the neural network 2 (S13). If the test in FIG. 4 is executed and an appropriate output is acquired as the classification output, the test is successfully completed. Conversely, if an appropriate output is not acquired as the classification output, the test failed. In this case, for example, the teaching data is changed, and learning is performed again.

FIG. 9 shows an example of the classification outputs acquired in a case where inference is performed using training data P21 to P23 that are similar to those in FIG. 2 when the test in FIG. 4 has been successfully completed. In the present embodiment, as shown in FIG. 9, the classification output of “unknown” is acquired for P22.

Thus, in the present embodiment, in the learning of the neural network, the training losses are calculated, and for the teaching data the training loss for which is higher than the predetermined threshold, the correct answer information is changed to “unknown”, to thereby be capable of improving the inference accuracy of the inference model even in the case where the teaching data includes the unsuitable image. Therefore, in creating the teaching data, there is no need for performing operation for removing the unsuitable image, which enables the efficiency of the annotation operation to be increased without deteriorating the inference accuracy of the neural network.

### Second Embodiment

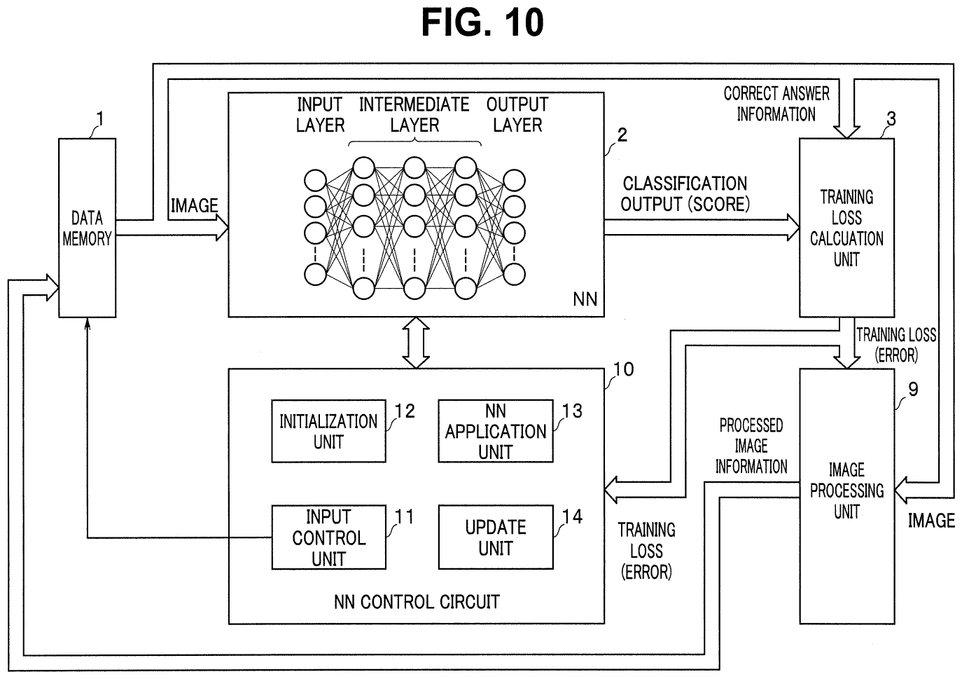

FIG. 10 is a block diagram showing the second embodiment of the present disclosure. In FIG. 10, the same constituent elements as those in FIG. 1 are attached with the same reference signs and descriptions thereof will be omitted.

In the first embodiment, the inference accuracy of the neural network is improved by performing the learning such that the unsuitable image is classified into the category of “unknown” by processing the correct answer information corresponding to the image, the training loss for which meets the predetermined reference. In contrast, in the present embodiment, the inference accuracy of the neural network is improved by processing an image, the training loss for which meets the predetermined reference such that the image is surely classified as an unsuitable image. Hereinafter, description will be made by taking the case where a threshold is used as the predetermined reference, as an example. However, also the present embodiment is not limited to the case.

The neural network update device in the second embodiment is different from the neural network update device in FIG. 1 in that the training loss recalculation unit 5 is omitted and an image processing unit 9 is employed in place of the correct answer information processing unit 4. The image processing unit 9 as a teaching data correction unit compares each of the training losses (loss values) acquired from the training loss calculation unit 3 with a predetermined threshold, to determine whether the training loss exceeds the predetermined threshold. In other words, the image processing unit 9 selects, among the output data, relevant output data, the loss value for which meets the predetermined reference, and irrelevant output data, the loss value for which does not meet the predetermined reference (the training loss is equal to or smaller than the predetermined threshold). Note that the image processing unit 9 may select, among the output data, the output data within a predetermined number in an order starting from the one, the loss value for which is the largest, as the relevant output data.

The correct answer information processing unit 4 processes the training data compared with the relevant output data, the training loss for which exceeds the predetermined threshold, that is, the loss value for which meets the predetermined reference. Specifically, the image processing unit 9 receives the images corresponding to the respective training losses from the data memory 1, and regarding the image corresponding to the training loss exceeding the predetermined threshold, that is, the training loss in which an error between the classification output and the correct answer information is relatively large, the image is processed into an image which is likely to be classified as “unknown”. For example, the image processing unit 9 may perform blurring processing on the image corresponding to the training loss exceeding the predetermined threshold. Furthermore, for example, the image processing unit 9 may perform image processing, such as decreasing the brightness of the image, lowering the resolution of the image, reducing the size of a lesion part in the image, or the like. The processed image information (processed training data) acquired by the image processing by the image processing unit 9 is provided to the data memory 1, to be stored in place of the original image.

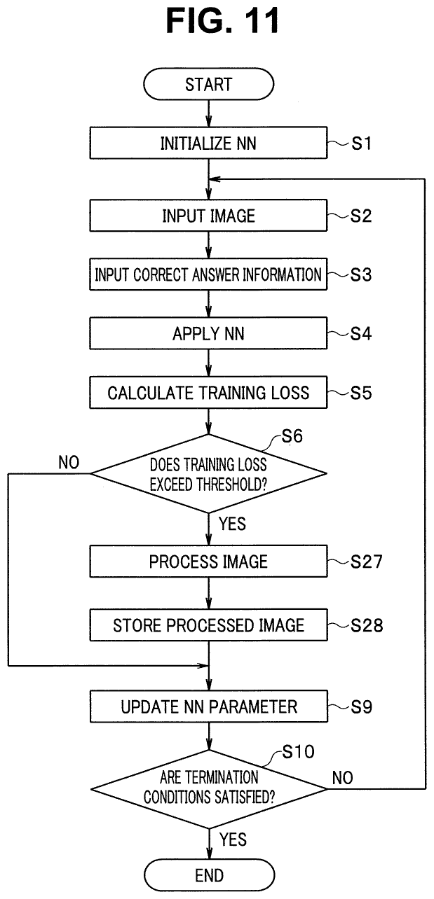

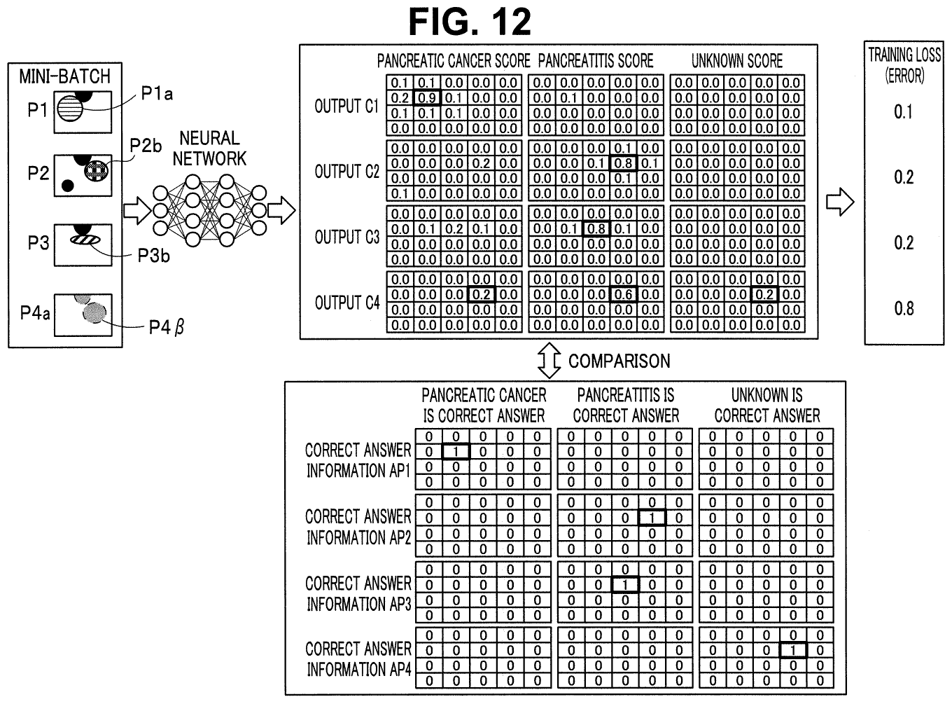

Next, the operation of the embodiment thus configured will be described with reference to FIGS. 11 to 15. FIG. 11 is a flowchart for explaining the operation of the second embodiment. In FIG. 11, the same processing steps as those in FIG. 3 are attached with the same reference signs and descriptions thereof will be omitted. FIGS. 12 to 15 are explanatory diagrams each explaining the operation of the second embodiment.

The processing steps in S1 to S5 in FIG. 11 are the same as those in FIG. 5. FIG. 12 shows the learning processing in the same manner as in FIG. 5. The left end part of FIG. 12 shows a mini-batch composed of four images P1, P2, P3, and P4a, which are training data. The images P1 to P3 are the same as the images P1 to P3 in FIG. 5. The image P4a is an unsuitable image including a blurred image part P40 of pancreatitis. Note that when there is no need to distinguish among the images P1 to P4a, the images P1 to P4a may be referred to as an image P representatively. The lower part of FIG. 12 shows an example of pieces of correct answer information AP1 to AP4 for the images P1, P2, P3, and P4a, in the same manner as in FIG. 5. The pieces of correct answer information AP1 to AP3 for the images P1 to P3 are the same as those in FIG. 5. In the present embodiment, since the image P4a is an unsuitable image, the correct answer information AP4 corresponding to the image P4a is set such that a region corresponding to the blurred image part P40 is set to “unknown” in advance, as shown by the bold frame portion.

The NN application unit 13 applies such a mini-batch to the neural network 2 (S4). Then, the neural network 2 outputs the classification outputs shown in the upper middle part of FIG. 12. The outputs C1 to C4 in FIG. 12 show the classification outputs of the neural network 2 for the images P1, P2, P3, and P4a. The outputs C1 to C3 in FIG. 12 include the same scores as those in FIG. 5.

In the output C4 corresponding to the image P4a, for the region of the image part P40 of the image P4a, the score of pancreatic cancer is 0.2 (bold frame portion), the score of pancreatitis is 0.6 (bold frame portion), and the score of “unknown” is 0.2 (bold frame portion). In other words, these scores show that the image P4a will be classified as pancreatitis with a relatively high probability in the neural network 2, although the image P4a is an unsuitable image in which blurring occurs.

Each of the classification outputs of the neural network 2 is provided to the training loss calculation unit 3 and the training loss is calculated (S5). The right end part of FIG. 12 shows the training loss values for the images P1, P2, P3, and P4a. As shown in FIG. 12, for the images P1 to P3, the probability of pancreatic cancer or pancreatitis is relatively high, and the training loss is 0.1 or 0.2, which is relatively small. In contrast, the training loss for the image P4a is relatively large (0.8).

Thus, the example of FIG. 12 also includes the correct answer information set to “unknown” in advance at the stage of the annotation operation. However, the blurred image part P4a is originally a blurred image of pancreatitis. Therefore, the score of pancreatitis is relatively high, resulting in a relatively large error (training loss) between the score of pancreatitis and the score of “unknown” which is correct answer information. Therefore, if the parameters of the neural network 2 are updated based on such a training loss to perform learning, it can be considered that the inference accuracy of the neural network 2 deteriorates.

In view of the above, in the present embodiment, the inputted image is processed such that the unsuitable image is surely classified as “unknown”. The image processing unit 9 receives the training loss from the training loss calculation unit 3 and the image from the data memory 1. The training loss calculation unit 3 determines whether the training loss exceeds the threshold in S6. When it is supposed that the threshold is 0.7, for example, the training loss for the image P4a exceeds the threshold in the example in FIG. 12. When determining that the training loss exceeds the threshold (YES determination in S6 in FIG. 11), the image processing unit 9 performs image processing on the image P4a such that the image P4a is surely determined as “unknown” (S27). The image processing unit 9 can perform image processing such that the image is determined as “unknown”, by performing various kinds of known image processing. For example, the image processing unit 9 may use an averaging filter for averaging the respective regions of the image, to generate a more distinctive blurred image. Alternatively, the image processing unit 9 may perform processing for lowering the resolution or brightness of the image P4a. The image processing unit 9 stores, in the data memory 1, the information on the processed image after the image processing, in place of the original image (S28).

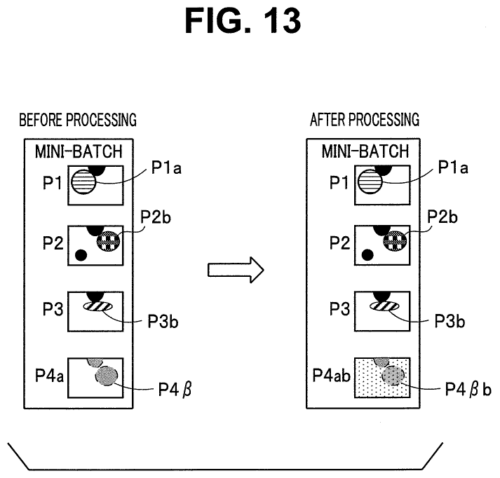

FIG. 13 shows a mini-batch obtained by the image processing. FIG. 13 shows, by the hatching, that the image P4a is changed into an image P4ab subjected to the blurring processing and the region of pancreatitis becomes a more blurred image part P40b. Note that FIG. 13 shows an example in which the image processing has been performed on the entire region of the image P4a. However, the image processing may be performed only on the image part P40. The update unit 14 of the neural network 2 updates the parameters of the neural network 2 based on the inputted training loss by the SGD method, for example (S9). When the termination conditions are not satisfied (NO determination in S10 in FIG. 11), the neural network 2 is applied by using the updated parameters and the changed mini-batch.

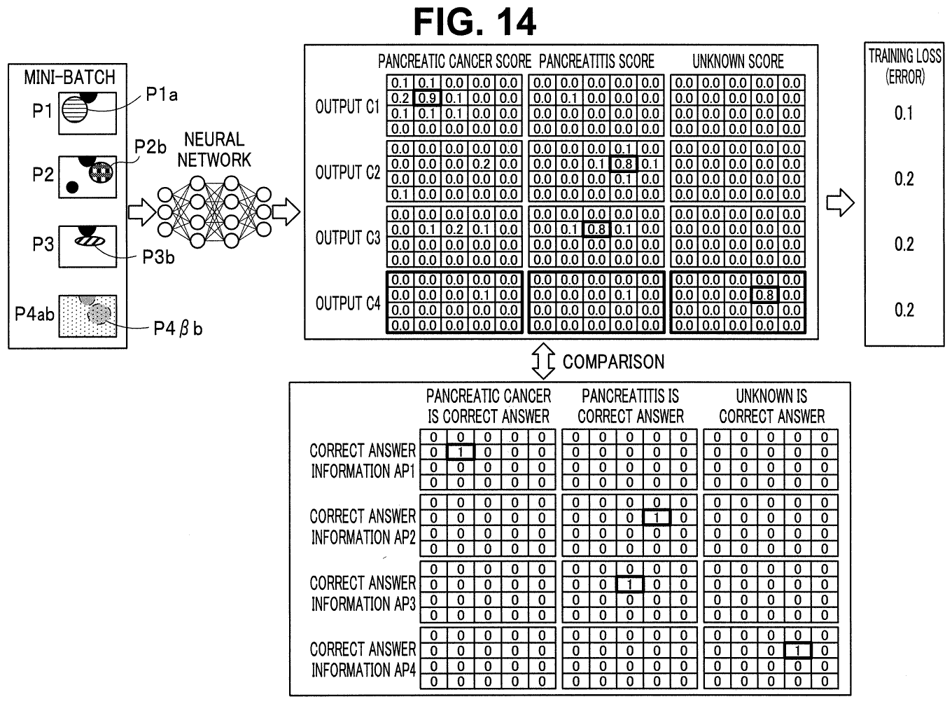

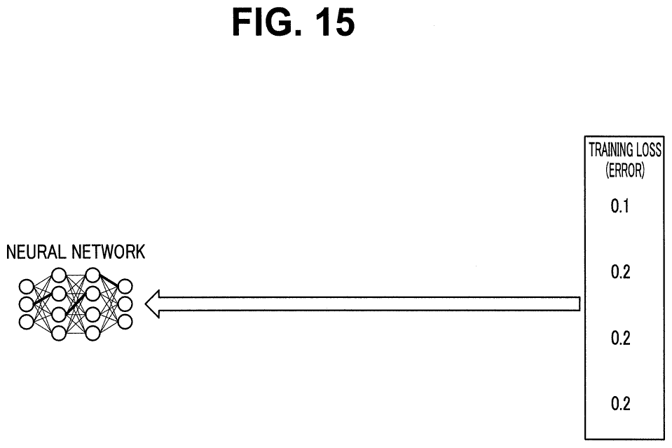

FIG. 14 shows, in the same manner as in FIG. 12, the classification outputs (processed output data) acquired in this case. As shown in the upper middle part of FIG. 14, the output C4 shown by the bold frames has changed from the previous classification output, and the score of “unknown” is the highest (0.8) for the image P4ab. As a result, the value of the training loss (processed loss value) of the classification output for the image P4ab is sufficiently small (0.2). As shown in FIG. 15, the update unit 14 updates the parameters of the neural network 2 based on the sufficiently small training loss thus acquired, to thereby enable a high inference accuracy of the neural network 2 acquired finally as a result of the learning.

### (Modification 1)

In each of the above-described embodiments, description has been made by taking the case where the type of the lesion part is identified, as an example. However, the present disclosure is not limited to the case. The present disclosure may cause the neural network 2 to identify the type of the organ, which is an observation target, a degree of progress of a lesion, a degree of invasion of the lesion, or a presence or absence of past treatment, or cause the neural network 2 to estimate a blood vessel region or a size of the lesion part. An example of the above-described past treatment may include a removal of Helicobacter pylori, for example.

### (Modification 2)

In the above-described embodiments, determination has been made on whether the loss value meets the predetermined reference after combining all of the information on the images classified as pancreatic cancer and the information on the images classified as pancreatitis. However, the present disclosure is not limited to this.

For example, in the case of selecting, among the output data, the output data within a predetermined number in an order starting from the one, the loss value for which is the largest, as relevant output data, the determination on whether the loss value meets the predetermined reference may be made on each of the information on the images classified as pancreatic cancer and the information on the images classified as pancreatitis.

In addition, in the case of selecting, among the output data, the output data within a predetermined number in an order starting from the one, the loss value for which is the smallest, as the irrelevant output data, the determination on whether the loss value meets the predetermined reference may be made on each of the information on the images classified as pancreatic cancer and the information on the images classified as pancreatitis.

Furthermore, in the modification 2, the object to be classified may be combined with the one in the modification 1. For example, among each of information on images classified as pharynx, information on images classified as esophagus, and information on images classified as stomach, information on five images in the order starting from the one, the loss value for which is the smallest, may be selected as irrelevant output data, and information on the remaining images may be selected as the relevant output data. Such a configuration has an advantage that the amount of information on the images in each of the categories such as the pharynx, esophagus, and stomach can be made uniform, to thereby be capable of reducing a deterioration of the classification performance.

Thus, in the present embodiment, in the learning of the neural network, the training losses are calculated, and for the teaching data, the training loss for which is higher than the predetermined threshold, the image corresponding to the training loss is processed, to thereby be capable of improving the inference accuracy of the inference model even in the case where the teaching data includes an unsuitable image. Therefore, in creating the teaching data, there is no need for performing the operation for removing the unsuitable image, which enables the efficiency of the annotation operation to be increased without deteriorating the inference accuracy of the neural network.

The present disclosure is not limited to the above-described embodiments as they are, and the disclosure can be embodied by modifying the constituent elements in a range without departing from the gist of the disclosure at the practical stage. In addition, various disclosures can be achieved by appropriately combining the plurality of constituent elements disclosed in each of the above-described embodiments. Some of the constituent elements may be deleted from all the constituent elements shown in the embodiments, for example. Furthermore, constituent elements over different embodiments may be appropriately combined.

Among the above-described techniques, many of the control and functions mainly described in the flowcharts can be set by a program, and the above-described control and functions can be implemented by the program being read and executed by a computer. The entirety or a part of the program can be recorded or stored, as a computer program product, in a portable medium such as a flexible disk, a CD-ROM, a non-volatile memory, or the like, or a storage medium such as hard disk, a volatile memory, or the like. The program can be distributed or provided at the time of product shipment or through a portable medium or a communication line. It is possible for a user to easily implement the neural network update device according to the present embodiment by downloading the program through a communication network to install the program into a computer, or installing the program from a recording medium into the computer.

What is claimed is:

1. A neural network update device comprising
a processor comprising hardware, the processor being configured to:
with respect to a plurality of output data obtained as a result of inputting a plurality of training data into a neural network,
compare the plurality of output data with a plurality of pieces of correct answer information associated with the plurality of training data, to calculate a loss value for each of the plurality of output data;
select, among the plurality of output data, relevant output data, the loss value for which meets a predetermined reference, and irrelevant output data, the loss value for which does not meet the predetermined reference; and
create processed correct answer information by processing the correct answer information compared with the relevant output data, compare the relevant output data with the processed correct answer information to output a processed loss value, and update the neural network by using the processed loss value, or
create processed training data by processing the training data associated with the relevant output data, input the processed training data into the neural network, to cause the neural network to output processed output data obtained as a result of classifying the processed training data, compare the processed output data with the correct answer information associated with the relevant output data, to output a processed loss value, and update the neural network by using the processed loss value.

2. The neural network update device according to claim 1, wherein the processor is further configured to update the neural network by changing a weighting factor of the neural network.

3. The neural network update device according to claim 1, wherein the processor is further configured to update the neural network by using the loss value associated with the irrelevant output data in addition to the processed loss value.

4. The neural network update device according to claim 1, wherein the processor is further configured to create the processed correct answer information by imparting a category of unsuitable recognition to the correct answer information compared with the relevant output data.

5. The neural network update device according to claim 1, wherein the processor is further configured to create the processed training data by performing image processing on the training data associated with the relevant output data.

6. The neural network update device according to claim 5, wherein the image processing includes processing for lowering a resolution of an image.

7. The neural network update device according to claim 1, wherein the predetermined reference defines, among the plurality of output data, output data within a top predetermined number in an order starting from the output data, the loss value for which is the largest, as the relevant output data.

8. The neural network update device according to claim 1, wherein the predetermined reference defines, among the plurality of output data, output data within a top predetermined number in an order starting from the output data, the loss value for which is the smallest, as the irrelevant output data.

9. The neural network update device according to claim 1, wherein the predetermined reference defines the output data, the loss value for which is equal to or larger than a predetermined value, as the relevant output data.

10. The neural network update device according to claim 1, wherein the plurality of training data include images picked up by an endoscope.

11. A non-transitory recording medium recording a neural network update program, the neural network update program being configured to cause a neural network update device to execute,
with respect to a plurality of output data obtained as a result of inputting a plurality of training data into a neural network,
processes of:
comparing the plurality of output data with a plurality of pieces of correct answer information associated with the plurality of training data, to calculate a loss value for each of the plurality of output data;
selecting, among the plurality of output data, relevant output data, the loss value for which meets a predetermined reference, and irrelevant output data, the loss value for which does not meet the predetermined reference; and
creating processed correct answer information by processing the correct answer information compared with the relevant output data, comparing the relevant output data with the processed correct answer information, to output a processed loss value, and updating the neural network by using the processed loss value, or
creating processed training data by processing the training data associated with the relevant output data, inputting the processed training data into the neural network to cause the neural network to output processed output data obtained as a result of classifying the processed training data, comparing the processed output data with the correct answer information associated with the relevant output data to output a processed loss value, and updating the neural network by using the processed loss value.

12. The non-transitory recording medium recording the neural network update program according to claim 11, wherein the program is further configured to cause the neural network update device to execute a process of updating the neural network by changing a weighting factor of the neural network.

13. The non-transitory recording medium recording the neural network update program according to claim 11, wherein the program is further configured to cause the neural network update device to execute a process of updating the neural network by using the loss value associated with the irrelevant output data in addition to the processed loss value.

14. The non-transitory recording medium recording the neural network update program according to claim 11, wherein the program is further configured to cause the neural network update device to execute a process of creating the processed correct answer information by imparting a category of unsuitable recognition to the correct answer information compared with the relevant output data.

15. The non-transitory recording medium recording the neural network update program according to claim 11, wherein the plurality of training data include images picked up by an endoscope.

16. A neural network update method by using a neural network update device, the neural network device comprising a teaching data acquisition unit, a neural network application unit, and a teaching data correction unit, the method comprising:
acquiring teaching data including a plurality of training data and a plurality pieces of correct answer information associated with the plurality of training data, by the teaching data acquisition unit;
inputting the plurality of training data into a neural network to cause the neural network to output a plurality of output data, which are obtained as a result of classifying the plurality of training data and which are associated respectively with the plurality of training data, by the neural network application unit;
comparing the plurality of output data with the plurality of pieces of correct answer information associated with the plurality of training data to calculate a loss value for each of the plurality of output data, by the neural network application unit;
selecting, among the plurality of output data, relevant output data, the loss value for which meets a predetermined reference, and irrelevant output data, the loss value for which does not meet the predetermined reference, by the neural network application unit; and
creating, by the teaching data correction unit, processed correct answer information by processing the correct answer information compared with the relevant output data, comparing, by the neural network application unit, the relevant output data with the processed correct answer information, to output a processed loss value, and updating, by the neural network application unit, the neural network by using the processed loss value, or
creating, by the teaching data correction unit, processed training data by processing the training data associated with the relevant output data, inputting, by the neural network application unit, the processed training data into the neural network to cause the neural network to output processed output data obtained as a result of classifying the processed training data and comparing the processed output data with the correct answer information associated with the relevant output data to output a processed loss value, and updating, by the neural network application unit, the neural network by using the processed loss value.

17. The neural network update method according to claim 16, wherein the method further comprising,
updating the neural network by changing a weighting factor of the neural network.

18. The neural network update method according to claim 16, wherein the method further comprising,
updating the neural network by using the loss value associated with the irrelevant output data in addition to the processed loss value.

19. The neural network update method according to claim 16, wherein the method further comprising,
creating the processed correct answer information by imparting a category of unsuitable recognition to the correct answer information compared with the relevant output data.

20. The neural network update method according to claim 16, wherein the plurality of training data include images picked up by an endoscope.
